(19) United States
(12) Patent Application Publication
(10) Pub. No.: US 2025/0088381 A1
(43) Pub. Date: Mar. 13, 2025

(54) Master-slave switching method and device

(71) Applicant: Zgmicro Wuxi Corporation, Wuxi (CN)

(72) Inventors: Zihao GAO, Wuxi (CN); Bin XU, Wuxi (CN); Jianglin CHAN, Wuxi (CN)

(73) Assignee: Zgmicro Wuxi Corporation, Wuxi (CN)

(21) Appl. No.: 18/244,132

(22) Filed: Sep. 8, 2023

(30) Foreign Application Priority Data
Sep. 8, 2023 (CN) 202211097353.9

(51) Int. Cl. H04L 12/18; H04W 56/00; H04W 72/0446; H04W 72/30

(52) U.S. Cl. CPC H04L 12/185; H04W 56/001; H04W 72/0446; H04W 72/30

(57) ABSTRACT

A master-slave switching technique is described. The master-slave switching method comprises: broadcasting a master-slave switching message and waiting for a master-slave switching moment by a first device used as a master device in a broadcast isochronous group after determining that a master-slave switching with a target slave device in the broadcast isochronous group is required; switching an operating mode to a slave mode by the first device so that the first device becomes one slave device in the broadcast isochronous group when the master-slave switching moment arrives; and communicating with the master device in the broadcast isochronous group, by the first device switched to the slave device, based on a communication rule of the broadcast isochronous group before the master-slave switching. In this way, the master-slave switching between the master device and the target slave device can be achieved without changing the communication rule, i.e., seamless master-slave switching in the BIG is achieved.

### CROSS-REFERENCE OF RELATED APPLICATIONS

The present invention claims the priority of Chinese Patent Application No. 202211097353.9 filed in China on Sep. 8, 2022, the entire contents of which are incorporated herein by reference.

### BACKGROUND OF THE INVENTION

### Field of the Invention

The present invention relates to the technical field of Bluetooth communication, and in particular to a master-slave switching method and a device for performing the master-slave switching.

### Description of the Related Art

Bluetooth Low Energy (BLE) audio technology provides wireless broadcast communication method by using an Isochronous Channels protocol. Through a BIS (Broadcast Isochronous Stream) link and a Broadcast Isochronous Group (BIG) composed of multiple BIS links, point-to-multipoint unidirectional audio transmission can be achieved, and low-cost, high-speed, and low latency mono or stereo audio broadcasting can be achieved. In a broadcast isochronous group, a master device is provided for broadcasting and one or more slave devices are provided for receiving. A BIG communication system is a unidirectional communication system in which communication signals can only be sent from the master device to the slave devices. In the BIG communication system, only the master device can share its own audio to the slave devices. If one slave device wants to share its own audio with the master and other slave devices, it is necessary to make all devices exit the original BIG communication system and re-establish a new BIG communication system. At the same time, it is also necessary to ensure that the slave device that wants to share audio with other becomes the master device in the new BIG communication system.

When the original BIG communication system is canceled, the broadcasted audio will be interrupted, and it takes sometime time to re-establish the new BIG communication system and play the new audio, which affects the user experience. In addition, when re-establishing the BIG communication system, errors may occur due to incorrect reception of signals sent by other master devices that are broadcasting.

### SUMMARY OF THE INVENTION

A purpose of the present invention is to provide a master-slave switching method and a master-slave switching device to realize the master-slave switching without terminating the original BIG.

To achieve the purpose, according to one aspect of the present invention, a master-slave switching method is provided. The master-slave switching method comprises: broadcasting a master-slave switching message and waiting for a master-slave switching moment by a first device used as a master device in a broadcast isochronous group after determining that a master-slave switching with a target slave device in the broadcast isochronous group is required; switching an operating mode to a slave mode by the first device so that the first device becomes one slave device in the broadcast isochronous group when the master-slave switching moment arrives; and communicating with the master device in the broadcast isochronous group, by the first device switched to the slave device, based on a communication rule of the broadcast isochronous group before the master-slave switching.

According to another aspect of the present invention, a master-slave switching method is provided. The master-slave switching method comprises: receiving, by a second device used as a slave device in a broadcast isochronous group, a master-slave switching message broadcasted by a master device in the broadcast isochronous group; waiting for a master-slave switching moment when it is confirmed that the second device is a target slave device requiring a master-slave switching based on the master-slave switching message; switching an operating mode to a master mode by the second device when the master-slave switching moment arrives; and communicating with the salve device in the broadcast isochronous group after the second device is switched to the master device based on a communication rule of the broadcast isochronous group before the master-slave switching.

According to yet another aspect of the present invention, a first device is provided. The first device comprises: a transceiver module configured for broadcasting a master-slave switching message and waiting for a master-slave switching moment when the first device is used as a master device in a broadcast isochronous group after determining that a master-slave switching with a target slave device in the broadcast isochronous group is required; and a switching module configured for switching an operating mode to a slave mode so that the first device becomes one slave device in the broadcast isochronous group when the master-slave switching moment arrives. The transceiver module is further configured for communicating with the master device in the broadcast isochronous group, after the first device is switched to the slave device, based on a communication rule of the broadcast isochronous group before the master-slave switching

One of the benefits, advantages and objectives the present invention, the devices in the broadcast isochronous group BIG can achieve seamless master-slave switching without changing the communication rule or re-establishing a new broadcast isochronous group BIG, with a short switching time and a better user experience.

### BRIEF DESCRIPTION OF THE DRAWINGS

These and other features, aspects, and advantages of the present invention will become better understood with regard to the following description, appended claims, and accompanying drawings wherein:

FIG. 1 is a flowchart of a master-slave switching method provided according to one embodiment of the present invention;

FIG. 2 shows a schematic diagram of a BLE broadcast communication system provided according to one embodiment of the present invention;

FIG. 3 shows a schematic diagram of a BLE broadcast time slot allocation provided according to one embodiment of the present invention;

FIG. 4 shows a schematic structure diagram of a BLE broadcast packet provided according to one embodiment of the present invention;

FIG. 5 is a flowchart of another master-slave switching method provided according to one embodiment of the present invention;

FIG. 6 shows a schematic diagram of a BIG communication system after master-slave switching provided according to one embodiment of the present invention;

FIG. 7 shows a schematic structure diagram of a first device provided according to one embodiment of the present invention;

FIG. 8 shows a schematic structure diagram of a second device provided according to one embodiment of the present invention;

FIG. 9 is a schematic structure diagram of a chip system provided according to one embodiment of the present invention; and

FIG. 10 shows a schematic structure diagram of a BLE control message packet provided according to one embodiment of the present invention.

### DETAILED DESCRIPTION OF THE PREFERRED

### Embodiments

The detailed description of the invention is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

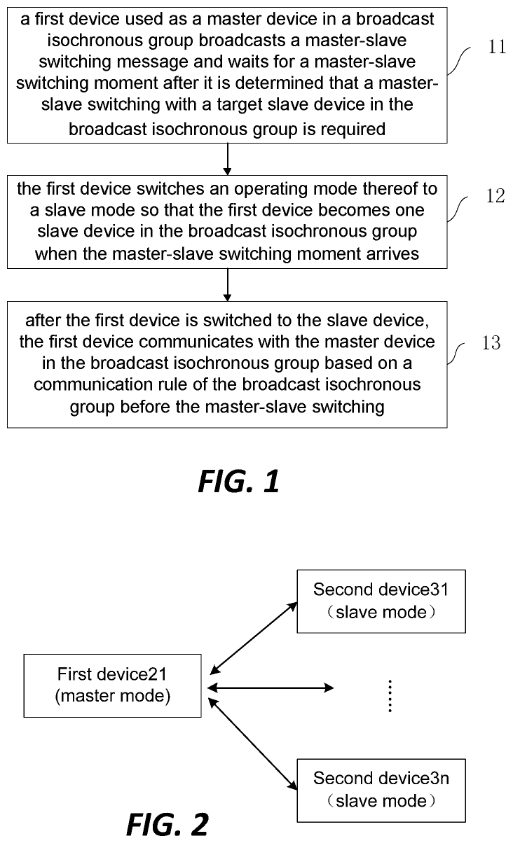

A master-slave switching method, a master-slave switching system, a chip system, and a storage medium provided according to embodiments of the present invention are described in detail below in conjunction with the accompanying drawings, by means of specific embodiments and their application scenarios. Referring now to FIG. 1, it is a flowchart of a master-slave switching method provided according to one embodiment of the present invention. Referring to FIG. 1, the master-slave switching method is applied to a BLE broadcast communication, and comprises following operations.

At 11, a first device used as a master device in a broadcast isochronous group broadcasts a master-slave switching message and waits for a master-slave switching moment after it is determined that a master-slave switching with a target slave device in the broadcast isochronous group is required. The master-slave switching method provided shown in FIG. 1 can be applied to the master device in a BLE broadcast communication system, i.e., the first device acts as the master device in the broadcast isochronous group BIG before the master-slave switching, and communicates with one or more slave devices in the broadcast isochronous group.

FIG. 2 shows a schematic diagram of a BLE broadcast communication system provided according to one embodiment of the present invention. As shown in FIG. 2, the BLE broadcast communication system comprises: a first device 21 operating in a master mode and being used as the master device in the BIG before the master-slave switching, and one or more second devices 31-3n each operating in a slave mode and being used as the slave device in the BIG before the master-slave switching. The first device 21 broadcasts according to a preset communication rule. The preset communication rule may be a BIG communication specification specified in a Bluetooth core specification. The second devices 31-3n may obtain necessary information for receiving broadcast by an external means. The external means may be BLE periodic advertising. According to the BIG communication specification specified in the Bluetooth core specification, the necessary information for receiving the BIG broadcast comprises a broadcast interval, an access code, a check code, a channel list, a time slot allocation scheme and the like. After searching for the BLE periodic advertising sent by the first device 21, the second devices 31-3n can synchronize with the first device 21 based on the necessary information to access the BIG communication system and communication with the first device 21.

At 12, the first device switches an operating mode thereof to a slave mode so that the first device becomes one slave device in the broadcast isochronous group when the master-slave switching moment arrives. At 13, after the first device is switched to the slave device, the first device communicates with the master device in the broadcast isochronous group based on a communication rule of the broadcast isochronous group before the master-slave switching.

It should be noted that, before and after the master-slave switching, the broadcast isochronous group BIG does not re-establish the BIG communication link, and the original broadcasting communication system is not reorganized. As shown in FIG. 2, when the master-slave switching between the first device 21 in the master mode and the target slave device such as the second device 31 in the slave mode occurs, other slave devices, such as the second devices 32-3n, in the broadcast isochronous group do not make any changes. Only the first device switches its operating mode in the broadcast isochronous group from the master mode to the slave mode after the master-slave switching, while the target slave device 31 switches its operating mode in the broadcast isochronous group from the slave mode to the master mode after the master-slave switching. That is, after the master-slave switching, roles of the first device 21 and the second device 31 are exchanged, and the other second devices still maintain their original roles and communicate according to the original communication rule.

In one embodiment, a communication event of the BLE broadcast communication comprises an advertising time slot. The master-slave switching method further comprises: broadcasting an advertising message in the advertising time slot before the first device determines that the master-slave switching with the target slave device in the broadcast isochronous group is required. The advertising message is configured for synchronizing the slave device with the master device and comprises a synchronization parameter for indicating the communication rule of the broadcast isochronous group.

As one specific embodiment, the synchronization parameter comprises a broadcast interval, an access code, a check code, a channel list and a time slot allocation scheme. Other slave devices search for the advertising message to access the broadcast isochronous group and synchronize with the master device in the broadcast isochronous group. It is to be understood that in the BLE broadcast communication, a start time of every two adjacent communication events differ by one broadcast interval.

In one embodiment, the first device switched to the slave device receives a new advertising message broadcasted by the master device in the advertising time slot. The new advertising message is generated based on the synchronization parameter for indicating the communication rule of the broadcast isochronous group.

In one embodiment, the communication event of the BLE broadcast communication comprises a control time slot. In one specific embodiment, after the first device used as the master device in the broadcast isochronous group determines that the master-slave switching with the target slave device in the broadcast isochronous group is required, the first device broadcasts a control message in the control time slot of at least one communication event. The control message comprises the master-slave switching message.

As one specific embodiment, the master-slave switching message comprises an indication for indicating the master-slave switching moment, and/or an identity of the target slave device. In one embodiment, the communication event of the BLE broadcast communication comprises a broadcast time slot. In one specific embodiment, after the first device used as the master device in the broadcast isochronous group determines that the master-slave switching with the target slave device in the broadcast isochronous group is required, the first device broadcasts a broadcast message in the broadcast time slot of the communication event before the control message is broadcasted. The broadcast message is configured to notify all the slave devices to receive the control message in the control time slot of a current communication event.

As one specific embodiment, the broadcast message may comprise: a control time slot identification bit for indicating that the control time slot will be used. In one embodiment, the master-slave switching moment is a starting moment of nth communication event after the first device determines that the master-slave switching with the target slave device in the broadcast isochronous group is required, n is a positive integer greater than or equal to 1.

For example, if the first device determines in the communication event 1000 that the master-slave switching with the target slave device is required, the master-slave switching moment is set to a starting moment of the 3rd communication event after the communication event 1000, i.e., the master-slave switching is performed from the starting moment of the communication event 1003.

In one embodiment, the control message comprises: an operator for indicating whether to perform the master-slave switching; an identification of the target slave device for indicating a Bluetooth address type and a Bluetooth address of the target slave device; an indicator for indicating the communication event number where the master-slave switching moment is located.

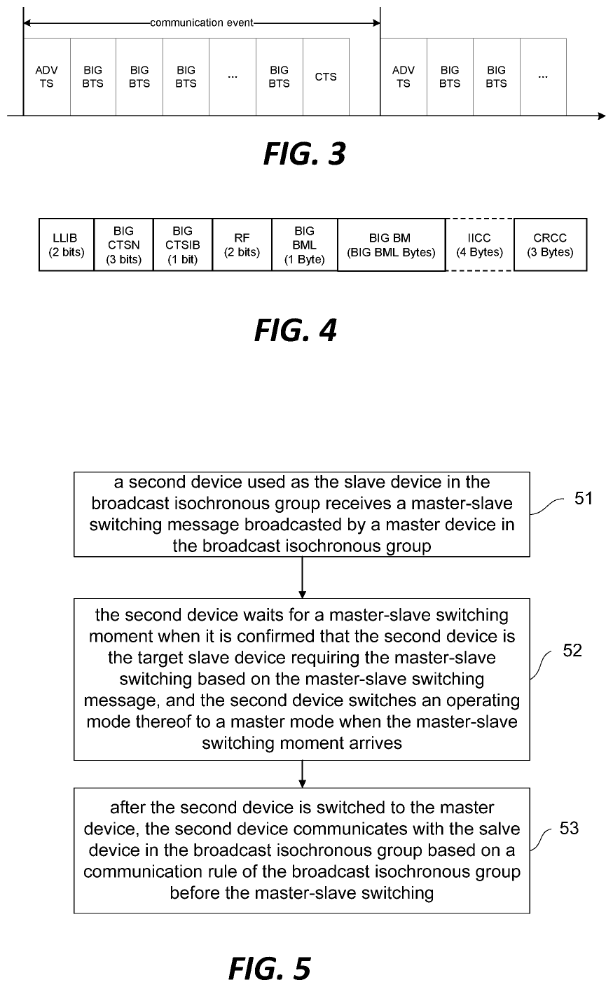

FIG. 3 shows a schematic diagram of a BLE broadcast time slot allocation for the BLE broadcast communication adopted by one embodiment of the present invention. In the BIG time slot allocation scheme illustrated in FIG. 3, the communication time is divided into consecutive communication events with consecutive communication event numbers (0, 1, 2, . . . ). Each communication event comprises one advertising time slot (abbreviated as ADV TS), one or more broadcast time slots (also known as BIG broadcast time slots, and abbreviated as BIG BTS), and one control time slot (also known as BIG control time slot and abbreviated as CTS).

The master device may periodically send the advertising message in the advertising time slot. Since the advertising message comprises the synchronization parameter for indicating the communication rule of the broadcast isochronous group, the slave device can synchronize with the master device according to the synchronization parameter after searching for the advertising message sent by the master device. As one specific embodiment, the advertising message may be encapsulated using a BLE periodical advertising packet type.

Referring to FIG. 3, the master device sends one BIG broadcast message in one BIG broadcast time slot. As one specific embodiment, the BIG broadcast message may be encapsulated using a BLE broadcast packet type in a format shown in FIG. 4. The BLE broadcast packet shown in FIG. 4 comprises a logical link identification bit (abbreviated as LLIB), a BIG control time slot sequence number (abbreviated as BIG CTSSN), a BIG control time slot identification bit (abbreviated as BIG CTSIB), a reserved field (abbreviated as RF), a BIG broadcast message length (abbreviated as BIG BML), a BIG broadcast message (abbreviated as BIG BM), and a cyclic redundancy check code (abbreviated as CRCC). Optionally, the BIG broadcast message further comprises an information integrity check code (abbreviated as IICC). The BIG broadcast message packet is used to carry the audio data that the master device wants to share, and the BIG control time slot identification bit is configured for indicating whether the BIG control timeslot is used in the current communication event or not. When the BIG control time slot is used, the master device sends the BIG control message in the BIG control time slot. The control message may be configured to control the BIG broadcast communication. For example, it is used to notify all the slave devices that the BIG broadcast is about to end.

FIG. 10 is a schematic structure diagram of a BLE control message packet. As shown in FIG. 10, when the slave device receives the BIG control message, the slave device determines whether the BIG control message is correct by means of an information integrity check code (abbreviated as IICC) and a cyclic redundancy check code (abbreviated as CRCC), determines the BIG control message to be information that needs to be received and processed by means of a logical link identification bit (abbreviated as LLIB), a BIG control time slot sequence number (abbreviated as BIG CTSSN), and a BIG control time slot identification bit (abbreviated as BIG CTSIB), determines the valid BIG control message by means of a BIG control message length (abbreviated as BIG CML), and determines whether the BIG control message is the master-slave switching message by an operator, determines whether it is the target slave device through a Bluetooth address type and a Bluetooth address of the target slave device (abbreviated as TSD), and knows the master-slave switching moment through the communication event number (abbreviated as CEN) where the master-slave switching moment (abbreviated as MSSM) is located.

As one specific embodiment, the BIG control message may be encapsulated using a BLE broadcast control packet type, the format of which is shown in FIG. 10. The BIG control message shown in FIG. 10 comprises an operator, a Bluetooth address type of the target slave device (TSD), a Bluetooth address of the target slave device (TSD), and the communication event number (CEN) where the master-slave switching moment (MSSM) is located.

The slave device does not need to receive the control message at every control time slot, and can determine which control time slot to receive the control message based on the broadcast message, which can save energy of the slave device to increase battery life, especially if the slave device is a wireless device, such as a Bluetooth headset, a Bluetooth speaker, and so on.

Notifying the slave device to receive the control message in the broadcast message of at least one communication event and sending the control message in the control time slot can enable all the slave devices in the BIG communication system to timely learn an intention of the master device and receive the control message in time so as to receive the master-slave switching message. Of course, it is also possible to send the control message in the control time slot of each of multiple communication events before the master-slave switching to prevent a situation in which the slave device does not receive it.

As one specific implementation, the master and slave devices may communicate in accordance with the BIG communication protocol before and after the master-slave switching. Therefore, when the operating mode of the first device is switched from the master mode to the slave mode, the first device may stop sending the synchronization parameter, the control message, the broadcast message, and the like. On the other hand, the second device switched to the master mode will act as the master device in the BIG communication system and send the synchronization parameter, the control message, and the broadcast message.

In one embodiment, after the first device determines that the master-slave switching with the target slave device is required, the first device stops sending the advertising message in the advertising time slot. After the first device determines that the master-slave switching is required, the first device stops sending the advertising message in the advertising time slot, which can avoid potential communication chaos caused by a new device accessing the BLE broadcast communication system during the period after determining the master-slave switching and before completing the master-slave switching.

In one embodiment, after the first device is switched to one slave device, the first device stops sending the control message comprising the master-slave switching message in the control time slot. In one embodiment, before the master-slave switching moment, the first device may periodically send the control message comprising the master-slave switching message in the control time slot of the communication event, or may send the control message comprising other control commands as needed. The slave device in the BIG communication system continues to receive the control messages from the first device until the master-slave switching moment arrives. After the master-slave switching moment arrives, the first device is switched to the slave device and stops sending the control message. Of course, within a system that allows bi-directional transmission of the control message, the first device used as the slave device may also send the control message to the master device. The present invention does not specifically limit this.

In one embodiment, the master-slave switching method further comprises: after the first device is switched to the slave device, the first device stops broadcasting the broadcast message for notifying the slave device to receive the control message in the control time slot of the current communication event. In one embodiment, the first device may continue to send the broadcast message carrying a first audio data within the broadcasting time slot of the communication event in accordance with a predetermined audio data sharing schedule until the master-slave switching moment arrives. The slave device in the BIG communication system continues to receive the first audio data shared by the first device until the master-slave switching moment arrives. After the master-slave switching moment arrives, the first device is switched to the slave device and stops sending the broadcast message. Of course, within a system that allows bi-directional broadcasting, the first device in the slave mode may also send the broadcast message in accordance with the broadcasting time slot of the slave device. The present invention does not specifically limit this.

In one embodiment, before the master-slave switching moment arrives, the first device broadcasts the broadcast message carrying the first audio data in the broadcast time slot of the communication event and stores the first audio data in a to-be-played cache. After the master-slave switching moment arrives, the first device receives the broadcast message carrying the second audio data in the broadcast time slot of the communication event, stores the second audio data into the to-be-played cache following the first audio data.

Thus, the first device retains the sent audio data in the to-be-played cache until the master-slave switching moment arrives, and stores the received audio data in the to-be-played cache following the original cached audio data after the first device is switched to the slave device. In this way, the first device sequentially extracts audio data from the to-be-played cache when the first device plays the audio data, regardless of whether the master-slave switching is performed or not, so that smoothness of music playback can be ensured.

In summary, the above master-slave switching method provided according to the above mentioned embodiments of the present invention provides seamless switching between the first device and the target slave device in the BLE broadcast isochronous group BIG without changing the communication rule or re-establishing a new BLE broadcast isochronous group BIG.

The present invention has one or more of the following beneficial technical effects: before and after the master-slave switching, only role change of the master device and the target slave device in the communication system and the communication function change corresponding to the role change occur, and the BLE broadcast isochronous group BIG communication system still follows the communication rule before the master-slave switching to realize the seamless switching of the communication between the various devices of the BIG communication system before and after the master-slave switching, with a shorter switchover time and a better user experience.

FIG. 5 is a flowchart of another master-slave switching method provided according to one embodiment of the present invention. Referring to FIG. 5, the master-slave switching method is applied to a wireless broadcast communication, and comprises the following operations. At 51, a second device used as the slave device in the broadcast isochronous group receives a master-slave switching message broadcasted by a master device in the broadcast isochronous group.

The master-slave switching method provided according to one embodiment of the present invention can be applied to the slave device in the BLE broadcast communication system shown in FIG. 2. Before the master-slave switching, the second device used as the slave device in the broadcast isochronous group BIG communicates in the synchronous broadcasting group BIG. At 52, the second device waits for a master-slave switching moment when it is confirmed that the second device is the target slave device requiring the master-slave switching based on the master-slave switching message, and the second device switches an operating mode thereof to a master mode when the master-slave switching moment arrives.

At 53, after the second device is switched to the master device, the second device communicates with the salve device in the broadcast isochronous group based on a communication rule of the broadcast isochronous group before the master-slave switching. After switching from the slave mode to the master mode, the second device completes an identity switching with the original master device in the broadcast isochronous group BIG communication system before the master-slave switching and thereafter communicates in the broadcast isochronous group BIG communication system in the operating mode of the master device. That is, the second device follows the communication rule of the broadcast isochronous group before the master-slave switching, and communications with the slave devices in the broadcast isochronous group as the master device.

Therefore, in the master-slave switching method provided according to one embodiment of the present invention, before and after the master-slave switching, only the role change of the master device and the target slave device in the communication system and the communication function change corresponding to the role change occur, and the BLE broadcast isochronous group BIG communication system still follows the communication rule before the master-slave switching to realize the seamless switching of the communication between the various devices of the BIG communication system before and after the master-slave switching.

In one embodiment, the communication event of the BLE broadcast communication comprises an advertising time slot. Before the second device confirms that the second device is the target slave device requiring the master-slave switching based on the master-slave switching message, the master-slave switching method further comprises: the second device receives an advertising message sent by the master device, obtains a synchronization parameter based on the advertising message, synchronizes with the master device based on the synchronization parameter. The synchronization parameter is configured for indicating the communication rule of the broadcast isochronous group. After the second device is switched to the master device, a new advertising message is generated based on the synchronization parameter, and broadcasted in the advertising time slot.

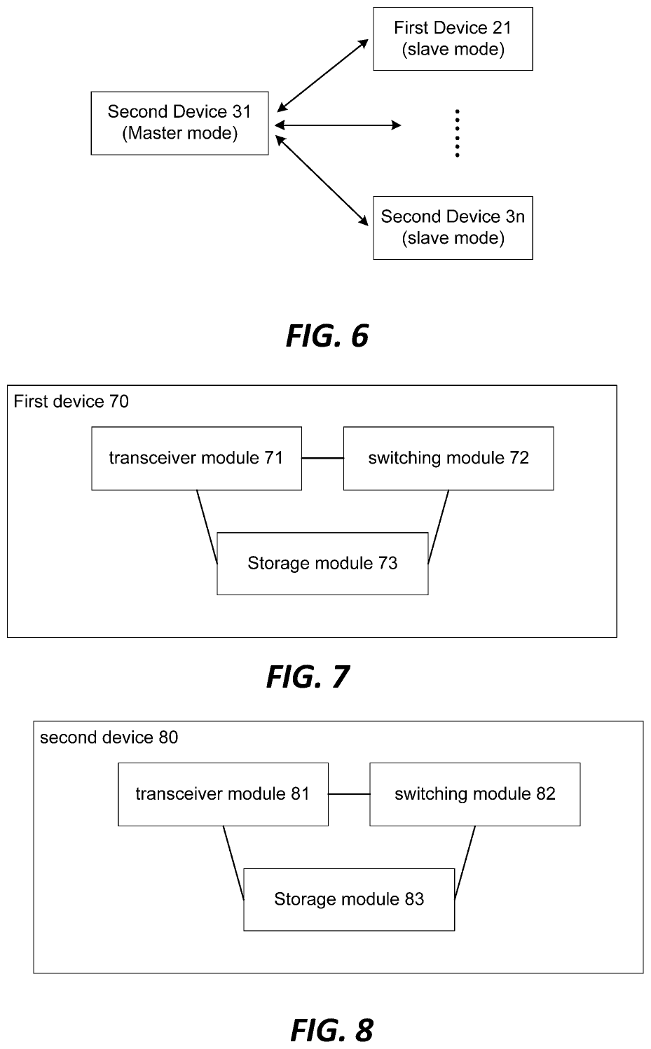

As shown in FIG. 2, the BLE broadcast communication system comprises: a first device 21 operating in the master mode and being used as the master device in the BIG before the master-slave switching, and one or more second devices 31-3n each operating in the slave mode and being used as the slave device in the BIG before the master-slave switching. Taking the second device 31 used as the slave device before the master-slave switching as an example, the second device 31 communicates with the first device 21 as the slave device in the BLE broadcast BIG communication system before the master-slave switching. After the master-slave switching, an identity switching occurs between the first device 21 and the second device 31. The first device 21 switches from the master device of FIG. 2 to the slave device of FIG. 6, and the second device 31 switches from the slave device of FIG. 2 to the master device of FIG. 6. Thus, after the second device 31 has been switched to the master mode, the second device 31 generates the new advertising message based on the synchronization parameter and sends the new advertising message during the advertising time slot.

In one embodiment, when the new advertising message is generated, the broadcast interval, the access code, the check code, the channel list and the time slot allocation scheme is used as the synchronization parameter in the new advertising message. Specifically, in order to achieve seamless switching of the master device and the target slave device, at least some of the synchronization parameter are kept unchanged, or it is also possible to require that all the synchronization parameter remain unchanged, or at least all the synchronization parameter affecting the seamless switching remain unchanged.

In one embodiment, the communication event of the BLE broadcast communication comprises a control time slot. The second device receives a control message sent by the master device in the control time slot of at least one communication event. The control message comprises the master-slave switching message.

Specifically, receiving the control message in the control time slot of at least one the communication event can enable the slave device to receive the master-slave switching message before the master-slave switching. Of course, it is also possible to receive the control message in the control time slot of each of multiple communication events before the master-slave switching in order to prevent a situation in which the slave device fails to receive it, such as the situation in which the target slave device fails to receive the master-slave switching message, it will cause the master-slave switching to fail.

In one embodiment, the communication event of the BLE broadcast communication comprises a broadcast time slot. The second device receives the broadcast message in the broadcast time slot of at least one communication event, and receives the control message broadcast by the master device in the control time slot of the current communication event when it is confirmed based on the received broadcast message that the control message should be received in the control time slot of the current communication event

The second device acting as the slave device obtains an identification bit of whether or not the control message needs to be received by receiving the broadcast message before the master-slave switching, and receives the control message sent by the master device in the control time slot based on the indication. This ensures that the control information is received by the second device before the master-slave switching, and the normal switching between the master device and the slave device can be achieved.

In one embodiment, if it is confirmed based on the master-slave switching message that the second device is not the target slave device requiring the master-slave switching, the master-slave switching method comprises: the second device communicates with the master device in the broadcast isochronous group continuously based on the communication rule of the broadcast isochronous group. When the second device is not the target slave device, the second device is not required to perform the operating of master-slave switching. Therefore, whether before or after the master-slave switching, the role of the second device in the BIG communication system remains unchanged, the second device follows the communication rule of the broadcast isochronous group, and continues to communication with the master device after the master-slave switching in the BIG communication system as the slave device.

In one embodiment, based on the Bluetooth address of the target slave device in the master-slave switching message, it is confirmed whether the second device is the target slave device requiring the master-slave switching designated by the master device. When the second device is confirmed to be the target slave device based on the master-slave switching message, the master-slave switching method further comprises: the second device determines the master-slave switching moment based on an indication for indicating the master-slave switching moment in the master-slave switching message.

Before the master-slave switching, each slave device determines whether it is the target slave device. If it is the target slave device, the slave device determines the master-slave switching moment so as to facilitate completion of the master-slave switching at the master-slave switching moment. In one embodiment, the communication event of the BLE broadcast communication comprises a broadcasting time slot.

Before the master-slave switching moment arrives, the second device receives a broadcast message carrying a first audio data in the broadcast time slot of the communication event and stores the first audio data in a to-be-played cache. After the master-slave switching moment arrives, the second device broadcasts a broadcast message carrying a second audio data in the broadcast time slot of the communication event, stores the second audio data into the to-be-played cache following the first audio data.

Exemplarily, the to-be-played cache is provided within the second device 31. The second device 31 retains the received audio data (the first audio data broadcast by the first device) in the to-be-played cache until the master-slave switching moment arrives. After the master-slave switching moment arrives, the second device 31 stores the second audio data into the to-be-played cache following the first audio data. In this way, the second device sequentially extracts the audio data from the to-be-played cache when the second device plays the audio data, regardless of whether or not the master-slave switching is performed, so that the smoothness of the music playback can be ensured.

In summary, the master-slave switching method provided according to the embodiments of the present invention provides the seamless switching between the master device and the target slave device in the BLE broadcast isochronous group BIG without changing the communication rule.

The present invention has one or more of the following beneficial technical effects: before and after the master-slave switching, only the role change of the master device and the target slave device in the communication system and the communication function change corresponding to the identity change occur, and the BLE broadcast isochronous group BIG communication system still follows the communication rule before the master-slave switching to realize the seamless switching of the communication between the various devices of the BIG communication system before and after the master-slave switching.

Exemplarily, the BLE broadcast isochronous group BIG communication system provided according to one embodiment of the present invention is shown in FIG. 2. The communication system comprises a first device 21, and one or more second devices 31-3n. The first device 21 in the master mode plays music in the BLE broadcast isochronous group, and the second devices 31-3n (slave mode) receive the music in the BLE broadcast isochronous group. Each device has unique identification, the identification comprises a 1 bit Bluetooth address type and a 6 Bytes Bluetooth address.

The first device 21 in the master mode uses the BLE broadcast time slot allocation as shown in FIG. 2. Each communication event is 10 milliseconds in length. Each communication event comprises 1 advertising time slot, 4 BIG broadcast time slots, and 1 BIG control time slot. The length of each advertising time slot is 0.625 milliseconds, and the length of each of the BIG broadcast time slots and the BIG control time slot is 1.25 milliseconds.

In the advertising time slot, the first device 21 sends the advertising message via a BLE periodic advertising packet. The advertising message comprises a broadcast interval, an access code, a check code, a channel list, a time slot allocation scheme, and the like.

In the BIG broadcasting time slot, the first device 21 sends music data via the BIG packet and stores the sent music data in a cache. The BIG packet is encapsulated using the BLE broadcast packet type, and the encapsulation format of which is shown in FIG. 4.

The slave device receives the BIG broadcast using the communication rule set by the master device, obtains the music data in the BIG packet, and stores the received music data into the cache.

The first device 21 and all the slave devices start playing the music data in the cache synchronously at an agreed time (such as 100 ms after the communication event where the first valid music data is located).

One slave device (the target slave device) wants to share its own music with other devices, so the target slave device and the master device decide to switch their roles.

The master device determines the master-slave switching moment and starts counting, and an end moment of the 10th communication event is scheduled as the master-slave switching moment.

After the master device determines the master-slave switching moment and starts counting, the master device stops using the advertising time slot in each communication event, i.e., the master device does not send the advertising message in the advertising time slot anymore. The master device notifies all the slave devices that the BIG control time slot is going to be used in the BIG broadcast message sent in each BIG broadcast time slot. The master device sends the BIG control message in the BIG control time slot to notify all the slave devices of the master-slave switching message. The master-slave switching message at least comprises the Bluetooth address of the target slave device, and the communication event number corresponding to the master-slave switching moment.

When the first device 21 notifying the slave devices that the BIG control time slots will be used, the master device then sets the BIG control time slot identification bit to 1 in each BLE broadcast packet in which the BIG broadcast message is located; sets the BIG control time slot sequence number to: BIG control time slot sequence number=(BIG control time slot sequence number before a decision moment+1) MOD 8.

The master device uses the BLE broadcast control packet type for encapsulation when the master device sends the master-slave switching message via the BIG control message, and its encapsulation format is shown in FIG. 10. In the BLE broadcast control packet illustrated in FIG. 10, the master device sets the logical link identification bit to 3, sets the BIG control time slot sequence number to be the same as the BIG control time slot sequence number carried in the BLE broadcast packet sent in the current communication event, sets the BIG control time slot identification bit to 0, sets the BIG control message length to 12. Referring to FIG. 10, the master device sets the operator in the BIG control message to 225 (0xE1) to indicate the master-slave switching message; sets the address type and the Bluetooth address of the target slave device to be the same as that of the target slave device; and sets the communication event number where the master-slave switching moment is located to a value determined by the master device.

The slave device learns in the BIG broadcast message received in the BIG broadcast time slot that the BIG control time slot will be used, and receives the BIG control message in the BIG control time slot. When the slave device receives the BIG control message, the slave device determines whether the BIG control message is correct by means of the information integrity check code and the cyclic redundancy check code, determines the BIG control message to be information that needs to be received and processed by means of the logical link identification bit, the BIG control time slot sequence number, and the BIG control time slot identification bit, determines the valid BIG control message by means of the BIG control message length (BIG CML), and determines whether the BIG control message is the master-slave switching message by the operator, determines whether it is the target slave device through the Bluetooth address type and the Bluetooth address of the target slave device (TSD), and knows the master-slave switching moment through the communication event number where the master-slave switching moment is located.

When the master-slave switching moment arrives, the master device becomes the slave device, for example, the first device 21 in the master mode shown in FIG. 2 is switched to the first device 21 in the slave mode shown in FIG. 6, and the first device 21 in the slave mode no longer transmits the BIG broadcast message and the BIG control message, but instead receives the BIG broadcast message in the original BIG broadcast time slot, and receives the control message in the original BIG control time slot. The original BIG communication rule comprising the broadcast interval, the access code, the check code, the channel list, the time slot allocation scheme, etc. is still used when receiving messages. The music data received in the BIG broadcast thereafter is stored in the cache for playback.

When the master-slave switching moment arrives, the target slave device becomes the master device, for example, the second device 31 in the slave mode in FIG. 2 is switched to the second device 31 in the master mode as shown in FIG. 6, the second device 31 in the master mode no longer receives the BIG broadcast message and the BIG control message, but instead sends the broadcast message in the original BIG broadcast time slot, sends the control message in the original BIG control time slot, and sends the advertising message in the original advertising time slot. The advertising message comprises the necessary information required for receiving the BIG broadcast. The original BIG communication rule comprising the broadcast interval, the access code, the check code, the channel list, the time slot allocation scheme, etc. is still used when sending messages. The music data sent thereafter in the BIG broadcast is stored in the cache for playback.

When the master-slave switching moment arrives, the slave devices other than the target slave device still receive the broadcasted messages in the original BIG broadcast time slot, and cache and play the music data in the original way.

FIG. 7 illustrates a first device 70 provided according to one embodiment of the present invention applied to a BLE broadcast communication. The first device 70 is used as the master device before the master-slave switching, and used as the slave device after the master-slave switching. The first device 70 comprises: a transceiver module 71 configured for broadcasting a master-slave switching message and waiting for a master-slave switching moment when the first device is used as a master device in a broadcast isochronous group after determining that a master-slave switching with a target slave device in the broadcast isochronous group is required; a switching module 72 configured for switching an operating mode to a slave mode by the first device so that the first device becomes one slave device in the broadcast isochronous group when the master-slave switching moment arrives.

The transceiver module 71 is further configured for communicating with the master device in the broadcast isochronous group after the first device is switched to the slave device based on a communication rule of the broadcast isochronous group before the master-slave switching. In one embodiment, the communication event of the BLE broadcast communication comprises an advertising time slot.

The transceiver module 71 is further configured for broadcasting an advertising message in the advertising time slot before the first device determines that the master-slave switching with the target slave device in the broadcast isochronous group is required, wherein the advertising message is configured for synchronizing the slave device with the master device and comprises a synchronization parameter for indicating the communication rule of the broadcast isochronous group.

When the transceiver module 71 communicates with the master device in the broadcast isochronous group after the first device is switched to the slave device, the transceiver module 71 is further configured for receiving a new advertising message broadcasted by the master device in the advertising time slot, wherein the new advertising message is generated based on the synchronization parameter for indicating the communication rule of the broadcast isochronous group.

In one embodiment, the transceiver module 71 is further configured to stop sending the advertising message in the advertising time slot after the first device determines that the master-slave switching with the target slave device in the broadcast isochronous group is required.

In one embodiment, the master-slave switching moment is a starting moment of nth communication event after the first device determines that the master-slave switching with the target slave device in the broadcast isochronous group is required, n is a positive integer greater than or equal to 1. In another embodiment, the communication event of the BLE broadcast communication comprises a control time slot.

The transceiver module 71 is further configured for broadcasting a control message in the control time slot of at least one communication event after the first device determines that the master-slave switching with the target slave device in the broadcast isochronous group is required, wherein the control message comprises the master-slave switching message.

In one embodiment, the transceiver module 71 is further configured to stop sending the control message comprising the master-slave switching message in the control time slot after the first device is switched to the slave device. In another embodiment, the communication event of the BLE broadcast communication comprises a broadcast time slot.

The transceiver module 71 is further configured for broadcasting a broadcast message in the broadcast time slot of the communication event after the first device determines that the master-slave switching with the target slave device in the broadcast isochronous group is required and before broadcasting the control message, wherein the broadcast message is configured to notify the slave device to receive the control message in the control time slot of a current communication event.

The transceiver module 71 is further configured to stop broadcasting the broadcast message in the broadcast time slot for notifying the slave device to receive the control message within the control time slot of the current communication event. In one embodiment, the communication event of the BLE broadcast communication comprises the broadcast time slot.

The first device 70 further comprising a storage module 73. The first device broadcasts the broadcast message carrying a first audio data in the broadcast time slot of the communication event and stores the first audio data in the storage module before the master-slave switching moment arrives.

After the master-slave switching moment arrives, the first device receives the broadcast message carrying a second audio data in the broadcast time slot of the communication event, stores the second audio data into the storage module 73 following the first audio data.

In one embodiment, the master-slave switching message comprises an indication for indicating the master-slave switching moment, and/or an identity of the target slave device. The broadcast message comprises: a BIG control time slot identification bit for indicating that the control time slot will be used. The synchronization parameter comprise: a broadcast interval, an access code, a check code, a channel list and a time slot allocation scheme.

In one embodiment, the control message comprises: an operator for indicating whether to perform the master-slave switching; an identification of the target slave device for indicating a Bluetooth address type and a Bluetooth address of the target slave device; an indicator for indicating the communication event number where the master-slave switching moment is located.

The first device 70 can realize the master slave device switching method provided in the above mentioned embodiment of the present invention, and can achieve the same technical effect. To avoid repetition, it will not be repeated here.

Referring to FIG. 8, a second device 80 is provided according to one embodiment of the present invention, and be applied to a BLE broadcast communication. The second device 80 is used as the slave device before the master-slave switching, and used as the master device after the master-slave switching. The second device 80 comprises a transceiver module 81 configured for receiving a master-slave switching message broadcasted by a master device in the broadcast isochronous group when a second device is used as a slave device in a broadcast isochronous group; a switching module 82 configured for waiting for a master-slave switching moment when it is confirmed that the second device is a target slave device requiring a master-slave switching based on the master-slave switching message; switching an operating mode to a master mode when the master-slave switching moment arrives.

The transceiver module 81 is further configured for communicating with the salve device in the broadcast isochronous group after the second device is switched to the master device based on a communication rule of the broadcast isochronous group before the master-slave switching.

In one embodiment, the communication event of the BLE broadcast communication comprises an advertising time slot. Before it is confirmed that the second device is the target slave device requiring the master-slave switching based on the master-slave switching message, the transceiver module 81 is further configured for receiving an advertising message broadcasted by the master device, obtaining a synchronization parameter based on the advertising message, synchronizing with the master device based on the synchronization parameter for indicating the communication rule of the broadcast isochronous group.

When the second device communicating with the salve device in the broadcast isochronous group after the second device is switched to the master device, the transceiver module 81 is further configured for generating a new advertising message based on the synchronization parameter, and broadcasting the new advertising message in the advertising time slot after the second device is switched to the master device.

In one embodiment, when the new advertising message is generated, a broadcast interval, an access code, a check code, a channel list, and a time slot allocation scheme are used as the synchronization parameter in the new advertising message. In one embodiment, the communication event of the BLE broadcast communication comprises a control time slot. The transceiver module 81 is further configured for receiving the control message broadcasted by the master device in the control time slot of at least one communication event, wherein the control message comprises the master-slave switching message.

In one embodiment, the communication event of the BLE broadcast communication comprising a broadcast time slot. The transceiver module 81 is further configured for receiving the broadcast message in the broadcast time slot of at least one communication event, and receiving the control message broadcast by the master device in the control time slot of the current communication event when it is confirmed based on the received broadcast message that the control message should be received in the control time slot of the current communication event.

In one embodiment, if it is confirmed based on the master-slave switching message that the second device is not the target slave device requiring the master-slave switching, the second device 80 is further configured to: continue to follow the communication rule of the broadcast isochronous group to communication with the master device in the broadcast isochronous group.

In one embodiment, the second device 80 is further configured for: confirming whether the present slave device is the target slave device designated by the master device based on a Bluetooth address of the target slave device in the master-slave switching message.

When the second device is confirmed to be the target slave device requiring the master-slave switching based on the master-slave switching message, the switching module 82 is further used to determine the master-slave switching moment based on an indication for indicating the master-slave switching moment in the master-slave switching message.

In one embodiment, the communication event of the BLE broadcast communication comprises a broadcast time slot. The second device 80 further comprises a storage module 83. The second device receives the broadcast message carrying a first audio data in the broadcast time slot of the communication event and stores the first audio data in the storage module 83 before the master-slave switching moment arrives.

The second device broadcasts the broadcast message carrying a second audio data in the broadcast time slot of the communication event, stores the second audio data into the storage module 83 following the first audio data after the master-slave switching moment arrives.

The second device 80 can realize the master slave device switching method provided in the above embodiments of the present invention, and can achieve the same technical effect. To avoid repetition, it will not be repeated here.

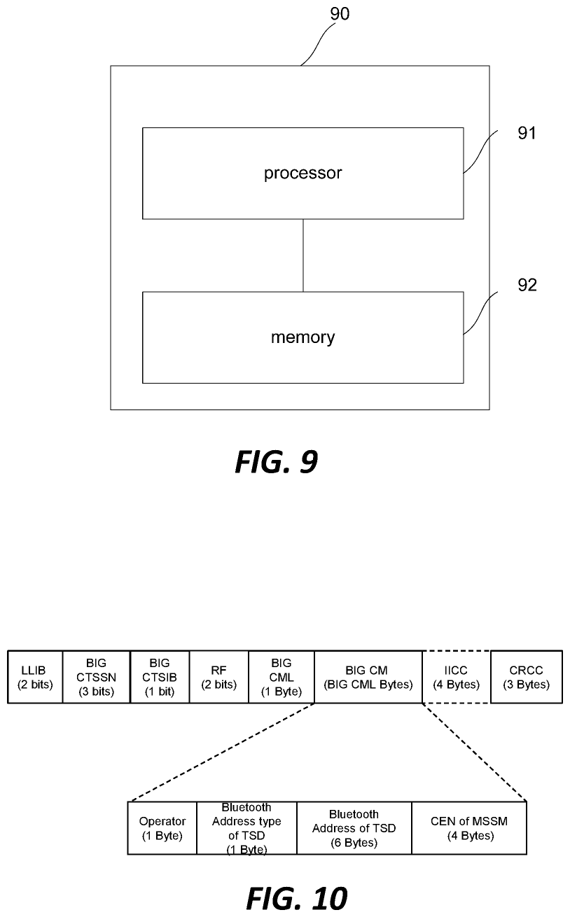

Referring to FIG. 9, a chip system 90 is provided according to one embodiment of the present invention. The chip system comprises a processor 91, and a memory 92. The chip system 90 can be mounted on an electronic device. The memory 92 stores a computer program, which is executed by the processor 91 to implement the master-slave switching method in the above mentioned embodiments, and can achieve the same technical effect. To avoid repetition, it will not be repeated here.

A readable storage medium is provided according to one embodiment of the present invention. The readable storage medium store a program. The program is executed by a processor to realize the various processes of the embodiments of the above-described audio broadcasting method, and can achieve the same technical effect. To avoid repetition, it will not be repeated here. The readable storage medium may be, such as a Read-Only Memory (ROM), a Random Access Memory (RAM), a magnetic disc or a compact disc.

Those skilled in the art should be aware that the embodiments of this application may be methods, systems, or computer program products. Accordingly, the present invention may take the form of a complete hardware embodiment, a complete software embodiment, or an embodiment in conjunction with software and hardware aspects. Furthermore, the present invention may take the form of a computer program product implemented on one or more computer-available storage media (comprising, but not limited to, disk memory, CD-ROM, optical memory, etc.) containing computer-available program code.

The present invention is described with reference to methods, equipment (systems), and flow charts and/or block diagrams of computer program products according to the embodiment of the present invention. It should be understood that each flow and/or block in a flowchart and/or block diagram, as well as the combination of flow and/or block in a flowchart and/or block diagram, can be implemented by computer program instructions. These computer program instructions may be provided to a processor of a general purpose computer, a dedicated computer, an embedded processor, or other programmable data processing device to produce a machine such that instructions executed by a processor of a computer or other programmable data processing device produce instructions for implementing a flow chart or more. A device for processes and/or block diagrams or functions specified in a box or multiple boxes.

These computer program instructions may also be stored in a computer-readable memory that may guide a computer or other programmable data processing device to work in a particular way, such that the instructions stored in the computer-readable memory generate a manufacturer comprising an instruction device that is implemented in a flow chart one or more processes. Process and/or block diagram, a box or function specified in multiple boxes.

These computer program instructions may also be loaded on a computer or other programmable data processing device such that a series of operational operations are performed on a computer or other programmable device to produce computer-implemented processing, thereby providing instructions executed on a computer or other programmable device for implementing a flow chart. The operations of a process or multiple processes and/or block diagrams, or functions specified in a box.

Although preferred embodiments of the present invention have been described, additional changes and modifications to these embodiments may be made once the basic creative concepts are known to those skilled in the art. The appended claims are therefore intended to be interpreted to comprise preferred embodiments and all changes and modifications falling within the scope of this application.

Obviously, a person skilled in the art may make various changes and variations to the application without departing from the spirit and scope of the application. Thus, if these modifications and variations of this application fall within the scope of the claims and their equivalent technologies, the application is also intended to comprise these changes and variations.

What is claimed is:

1. A master-slave switching method comprising:
broadcasting a master-slave switching message and waiting for a master-slave switching moment by a first device used as a master device in a broadcast isochronous group after determining that a master-slave switching with a target slave device in the broadcast isochronous group is required;
switching an operating mode to a slave mode by the first device so that the first device becomes a slave device in the broadcast isochronous group when the master-slave switching moment arrives; and
communicating with the master device in the broadcast isochronous group, by the first device switched to the slave device, based on a communication rule of the broadcast isochronous group before the master-slave switching.

2. The master-slave switching method according to claim 1, wherein a communication event of the BLE broadcast communication comprises an advertising time slot, the master-slave switching method further comprises:
broadcasting an advertising message in the advertising time slot before the first device determines that the master-slave switching with the target slave device in the broadcast isochronous group is required, wherein the advertising message is configured for synchronizing the slave device with the master device and comprises a synchronization parameter for indicating the communication rule of the broadcast isochronous group;
wherein said communicating with the master device in the broadcast isochronous group comprises:
receiving a new advertising message broadcasted by the master device in the advertising time slot, wherein the new advertising message is generated based on the synchronization parameter for indicating the communication rule of the broadcast isochronous group.

3. The master-slave switching method according to claim 1, wherein the master-slave switching moment is a starting moment of nth communication event after the first device determines that the master-slave switching with the target slave device in the broadcast isochronous group is required, n is a positive integer greater than or equal to 1.

4. The master-slave switching method according to claim 1, wherein a communication event of the BLE broadcast communication comprises a control time slot, said broadcasting a master-slave switching message comprises:
broadcasting a control message in the control time slot of at least one communication event after the first device determines that the master-slave switching with the target slave device in the broadcast isochronous group is required, wherein the control message comprises the master-slave switching message.

5. The master-slave switching method according to claim 4, wherein a communication event of the BLE broadcast communication comprises a broadcast time slot, and said broadcasting a master-slave switching message further comprises:
broadcasting a broadcast message in the broadcast time slot of the communication event after the first device determines that the master-slave switching with the target slave device in the broadcast isochronous group is required and before broadcasting the control message, wherein the broadcast message is configured to notify the slave device to receive the control message in the control time slot of a current communication event.

6. The master-slave switching method according to claim 2, wherein a communication event of the BLE broadcast communication comprises a broadcast time slot,
the first device broadcasts a broadcast message carrying a first audio data in the broadcast time slot of the communication event and stores the first audio data in a to-be-played cache before the master-slave switching moment arrives; and
the first device receives the broadcast message carrying a second audio data in the broadcast time slot of the communication event, stores the second audio data into the to-be-played cache following the first audio data after the master-slave switching moment arrives.

7. The master-slave switching method according to 6, wherein the master-slave switching message comprises an indication for indicating the master-slave switching moment, and/or an identity of the target slave device, the broadcast message comprises: a control time slot identification bit for indicating that the control time slot will be used, and the synchronization parameter comprise: a broadcast interval, an access code, a check code, a channel list and a time slot allocation scheme.

8. The master-slave switching method according to claim 7, wherein the control message comprises:
an operator for indicating whether to perform the master-slave switching;
an identification of the target slave device for indicating a Bluetooth address type and a Bluetooth address of the target slave device;
an indicator for indicating the communication event number where the master-slave switching moment is located.

9. A master-slave switching method, comprising:
receiving, by a second device used as a slave device in a broadcast isochronous group, a master-slave switching message broadcasted by a master device in the broadcast isochronous group;
waiting for a master-slave switching moment when it is confirmed that the second device is a target slave device requiring a master-slave switching based on the master-slave switching message;
switching an operating mode to a master mode by the second device when the master-slave switching moment arrives; and
communicating with the salve device in the broadcast isochronous group, after the second device is switched to the master device, based on a communication rule of the broadcast isochronous group before the master-slave switching.

10. The master-slave switching method according to claim 9, wherein a communication event of the BLE broadcast communication comprises an advertising time slot, before the second device is confirmed the target slave device requiring the master-slave switching based on the master-slave switching message, the master-slave switching method further comprises:
receiving an advertising message broadcasted by the master device, obtaining a synchronization parameter based on the advertising message, synchronizing with the master device based on the synchronization parameter for indicating the communication rule of the broadcast isochronous group, by the second device, wherein said communicating with the salve device in the broadcast isochronous group comprises:
generating a new advertising message based on the synchronization parameter, and broadcasting the new advertising message in the advertising time slot after the second device is switched to the master device.

11. The master-slave switching method according to claim 10, wherein said generating a new advertising message based on the synchronization parameter comprises: using a broadcast interval, an access code, a check code, a channel list, and a time slot allocation scheme as the synchronization parameter in the new advertising message.

12. The master-slave switching method according to claim 9, wherein a communication event of the BLE broadcast communication comprises a control time slot, and said receiving comprises: receiving, by a second device, a control message broadcasted by the master device in the control time slot of at least one communication event, wherein the control message comprises the master-slave switching message.

13. The master-slave switching method according to claim 12, wherein the communication event of the BLE broadcast communication comprises a broadcast time slot, and said receiving comprises: receiving the broadcast message in the broadcast time slot of at least one communication event, and receiving the control message broadcast by the master device in the control time slot of the current communication event when it is confirmed based on the received broadcast message that the control message should be received in the control time slot of the current communication event.

14. The master-slave switching method according to claim 9, wherein if it is confirmed based on the master-slave switching message that the second device is not the target slave device requiring the master-slave switching, the master-slave switching method comprises:
communicating with the master device in the broadcast isochronous group continuously based on the communication rule of the broadcast isochronous group.

15. The master-slave switching method according to claim 9, wherein whether the present slave device is the target slave device designated by the master device is confirmed based on a Bluetooth address of the target slave device in the master-slave switching message;
the master-slave switching moment is determined based on an indication for indicating the master-slave switching moment in the master-slave switching message.

16. The master-slave switching method according to claim 9, wherein a communication event of the BLE broadcast communication comprises a broadcast time slot,
the second device receives a broadcast message carrying a first audio data in the broadcast time slot of the communication event and stores the first audio data in a to-be-played cache before the master-slave switching moment arrives;
the second device broadcasts the broadcast message carrying a second audio data in the broadcast time slot of the communication event, stores the second audio data into the to-be-played cache following the first audio data after the master-slave switching moment arrives.

17. A first device comprising:
a transceiver module configured for broadcasting a master-slave switching message and waiting for a master-slave switching moment when the first device is used as a master device in a broadcast isochronous group after determining that a master-slave switching with a target slave device in the broadcast isochronous group is required; and
a switching module configured for switching an operating mode to a slave mode so that the first device becomes one slave device in the broadcast isochronous group when the master-slave switching moment arrives;
wherein the transceiver module is further configured for communicating with the master device in the broadcast isochronous group, after the first device is switched to the slave device, based on a communication rule of the broadcast isochronous group before the master-slave switching.

18. The first device according to claim 17, wherein a communication event of the BLE broadcast communication comprises an advertising time slot,
the transceiver module is further configured for broadcasting an advertising message in the advertising time slot before the first device determines that the master-slave switching with the target slave device in the broadcast isochronous group is required, wherein the advertising message is configured for synchronizing the slave device with the master device and comprises a synchronization parameter for indicating the communication rule of the broadcast isochronous group,
when the transceiver module communicates with the master device in the broadcast isochronous group after the first device is switched to the slave device, the transceiver module is further configured for receiving a new advertising message broadcasted by the master device in the advertising time slot, wherein the new advertising message is generated based on the synchronization parameter for indicating the communication rule of the broadcast isochronous group.

19. The first device according to claim 17, wherein the master-slave switching moment is a starting moment of nth communication event after the first device determines that the master-slave switching with the target slave device in the broadcast isochronous group is required, n is a positive integer greater than or equal to 1.

20. The first device according to claim 17, wherein a communication event of the BLE broadcast communication comprises a control time slot,
the transceiver module is further configured for broadcasting a control message in the control time slot of at least one communication event after the first device determines that the master-slave switching with the target slave device in the broadcast isochronous group is required, wherein the control message comprises the master-slave switching message.
